(19) United States
(12) Patent Application Publication
(10) Pub. No.: US 2025/0248362 A1
(43) Pub. Date: Aug. 7, 2025

(54) COMFORT MATTRESS FOR AN ANIMAL, IN PARTICULAR FOR EQUINES

(71) Applicant: GROUP ELASTOTECK, MOUZEIL (FR)

(72) Inventor: Jean-Vincent BIORET, PETIT-MARS (FR)

(73) Assignee: GROUP ELASTOTECK, MOUZEIL (FR)

(21) Appl. No.: 19/047,841

(22) Filed: Feb. 7, 2025

(30) Foreign Application Priority Data
Feb. 7, 2024 (FR) FR2401215

(51) Int. Cl. A01K 1/015

(52) U.S. Cl. CPC A01K 1/0157

(57) ABSTRACT

A comfort mattress, for an animal, in particular for equines. The comfort mattress includes two sheets made of elastic material, which define: a folding strip, suitable for folding the comfort mattress between a folded state, in two, and an unfolded state, and two sealed cavities, each containing a resilient layer and arranged on either side of the folding strip.

### TECHNICAL FIELD OF THE INVENTION

The present invention relates to the technical field of comfort mattresses, for an animal, in particular for equines.

### BACKGROUND

In the world of animal care, well-being and comfort are fundamental concerns.

In this sense, comfort mattresses have been developed for animals spending part of their time indoors. These mattresses have the advantage of providing adequate support, effective cushioning and appropriate thermal insulation.

However, in some situations, animal comfort is currently not managed satisfactorily, with the resulting physiological and behavioral risks.

This problem is particularly encountered when traveling by vehicle (truck or van), or when traveling to competitions.

### SUMMARY

In order to overcome the aforementioned drawback of the state of the art, the present invention proposes a comfort mattress for animals, in particular for equines.

The comfort mattress comprises two sheets, made of elastic material, namely:
a upper sheet, intended to form an upper face of said comfort mattress, and
a lower sheet, intended to form a lower face of the comfort mattress which is suitable for resting on the floor.

The sheets are joined together and define:
a folding strip, suitable for folding said comfort mattress between a folded state, in two, and an unfolded state, and
two sealed cavities, each containing a resilient layer and arranged on either side of said folding strip.

Such a technical solution has the advantage of forming a transportable comfort mattress.

Such a comfort mattress can be installed in a stall or in an equestrian vehicle (horse truck or horse van).

The animal's comfort is thus improved: the comfort mattress can then follow the animal in its movements. When the animal returns to its resting place, it is exposed to a familiar olfactory and sensory environment, inducing a calming response. This sensory familiarity contributes substantially to stress reduction, which strengthens its confidence and reduces susceptibility to environmental disturbances.

Other non-limiting and advantageous characteristics of the product according to the invention, taken individually or in all technically possible combinations, are as follows:
said comfort mattress has a rectangular outline comprising two longitudinal edges and two transverse edges, and said folding strip is arranged along a median line, preferably parallel to said longitudinal edges; preferably, in its unfolded state, said comfort mattress has the following dimensions: a width dimension ranging from 1,500 to 2,000 mm, and a length dimension ranging from 2,000 to 3,000 mm; preferably, said folding strip has a longitudinal axis, and a width dimension, perpendicular to said longitudinal axis, ranging from 40 mm to 200 mm;
in its folded state, said folding strip has a radius of curvature ranging from 40 to 80 mm;
said comfort mattress comprises a peripheral strip, delimiting said comfort mattress and surrounding said sealed cavities; said peripheral strip preferably comprises a width dimension ranging from 40 mm to 200 mm;
said sheets are secured at said folding strip and/or, where appropriate, said peripheral strip, for example by vulcanization;
said resilient layer is made of a foam plate, for example made of recycled or non-recycled material, for example made of elastomeric material, for example polyurethane or latex, advantageously with shape memory;
said resilient layer has a tensile strength ranging from 10 to 20 MPa, and an elongation capacity ranging from 300 to 500%;
each resilient layer has a top face, a bottom face and side faces, which bottom sheet conforms to the bottom face of said resilient layer, and which top sheet conforms to the top face and the side faces of said resilient layer;
each resilient layer has the shape of a parallelepiped plate;
said comfort mattress comprises at least one handle, suitable for handling said comfort mattress, which at least one handle is preferably provided in said peripheral strip, for example in the form of a cut-out and/or at the level of the folding strip, on the side of the lower sheet, for example in the form of a handle.

Of course, the various features, variants and embodiments of the invention may be combined with each other in various combinations to the extent that they are not incompatible or mutually exclusive.

### BRIEF DESCRIPTION OF THE FIGURES

In addition, various other characteristics of the invention emerge from the appended description made with reference to the drawings which illustrate non-limiting forms of embodiment of the invention and where:

FIG. 1 is a general and perspective view of a comfort mattress according to the invention, in its unfolded state;

FIG. 2 is a schematic and sectional view of the comfort mattress according to FIG. 1, along a section plane oriented perpendicular to the folding strip;

FIG. 3 is a general and perspective view of the comfort mattress according to FIG. 1, in its folded state;

FIG. 4 is a general and schematic view illustrating the layers suitable for the manufacture of the comfort mattress according to the invention.

It should be noted that, in these figures, the structural and/or functional elements common to the different variants may have the same references.

### DETAILED DESCRIPTION

The present invention thus relates to a comfort mattress 1 which is suitable for an animal, in particular for equines (for example for horses or donkeys).

This comfort mattress 1 comprises two sheets 2, 3, made of elastic material, namely:
an upper sheet 2, intended to form an upper face of the comfort mattress 1, and
a lower sheet 3, intended to form a lower face of the comfort mattress 1 which is adapted to rest on the ground.

Generally speaking, sheets 2, 3 are secured together and define:
a folding strip 5, suitable for folding the comfort mattress 1, and
two sealed cavities 6, each containing a resilient layer 7 and arranged on either side of the folding strip 5.

Other advantageous technical characteristics of this comfort mattress 1 are detailed below.

### Rectangular Outline

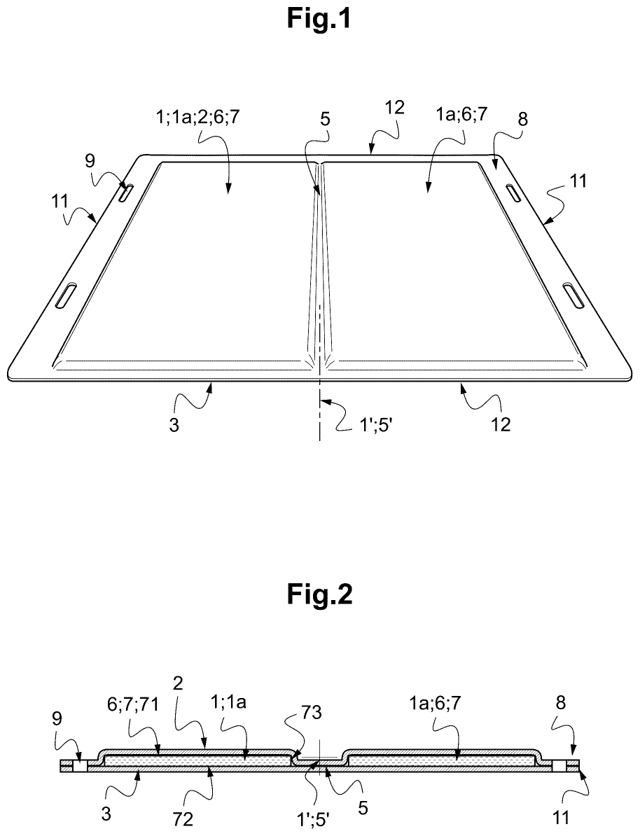

As illustrated in FIG. 1, in particular in an unfolded state, the comfort mattress 1 advantageously has a rectangular outline comprising two longitudinal edges 11 (long sides) and two transverse edges 12 (short sides).

The folding strip 5 is arranged along a center line 1′ of the comfort mattress 1, preferably parallel to the longitudinal edges 11.

In its unfolded state (FIG. 1), said comfort mattress 1 advantageously has the following dimensions:
a width dimension ranging from 1,500 to 2,000 mm (measured parallel to the transverse edges 12), and
a length dimension ranging from 2,000 to 3,000 mm (measured parallel to the longitudinal edges 11).

### Sheets Made of Elastomer Material

Each sheet 2, 3 is made from at least one material capable of undergoing elastic deformation, also called “elastic material”, chosen from:
elastomeric materials, namely for example natural rubber, “synthetic natural” rubber (or synthetic polyisoprene), polybutadiene or styrene-butadiene, or
plastic or thermoplastic elastomer (TPE) materials, for example PVB (polyvinyl butyral), ABS (acrylonitrile butadiene styrene)/SBR (styrene-butadiene), PP (polypropylene)/EPDM (ethylene-propylene-diene monomer), TPU (polyurethane TPE).

Each sheet 2, 3 is advantageously made in one piece, either single-material (in a single material) or multi-material (with at least two superimposed sub-layers made in different materials).

Each sheet 2, 3 may also contain at least one reinforcing sub-layer (not shown), chosen for example from textile fibers, metal fibers or any other product providing stability and/or resistance to elongation.

These reinforcing underlays consist, for example, of a textile frame serving as reinforcement, advantageously made of a material chosen from nylon, cotton, polyester, polyamide or any other reinforcing textile.

Furthermore, each sheet 2, 3 advantageously has a thickness ranging from 0.5 to 4 mm.

The sheets 2, 3 are advantageously secured at the level of the folding strip 5 and/or, where appropriate, a peripheral strip 8.

The assembly technology can be chosen, for example, from vulcanization, but also from gluing or welding.

### Folding Strip

Preferably, the folding strip 5 is constituted by a portion of the upper sheet 2 and by a portion of the lower sheet 3, superimposed on each other and separating the sealed cavities 6 (FIG. 2 in particular).

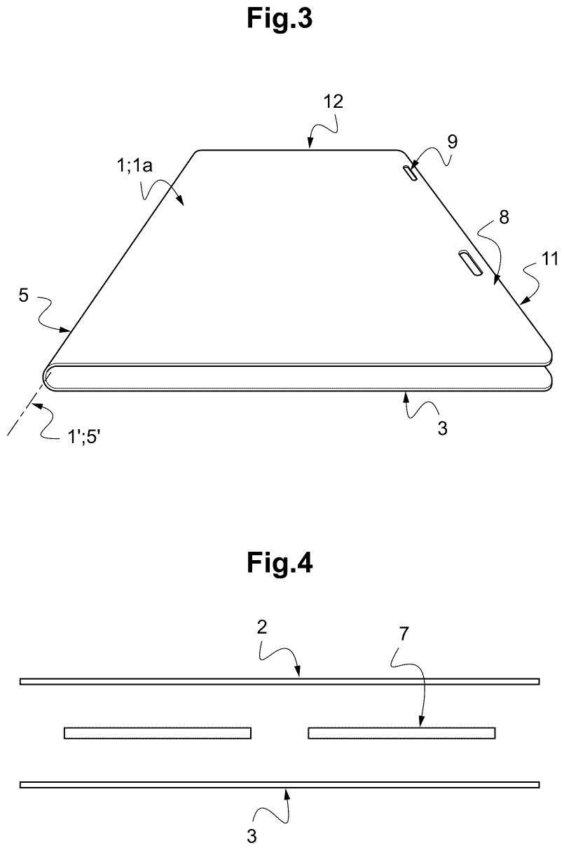

The folding strip 5 is suitable for a folding maneuver of the comfort mattress 1 between two states:
an unfolded state, advantageously flat, as illustrated in particular in FIG. 1, and
a folded state, in two, as illustrated in particular in FIG. 3.

The comfort mattress 1 thus comprises two flaps 1a, which are connected by the folding strip 5.

These two flaps 1a are movable in rotation relative to each other, around the folding strip 5.

Preferably, in the folded state, the two flaps 1a come to overlap on the side of the upper sheet 2.

Generally speaking, the folding strip 5 has a longitudinal axis 5′, coincident with a median line 1′ of the comfort mattress 1. The folding strip 5 is thus advantageously rectilinear.

Preferably, this folding strip 5 has a width dimension, perpendicular to this longitudinal axis 5′, ranging from 40 mm to 200 mm.

Preferably, this folding strip 5 has a rectangular shape, which is delimited by the sealed cavities 6.

In its folded state, said folding strip 5 advantageously has a radius of curvature ranging from 40 to 80 mm.

The folding strip 5 advantageously extends parallel to the longitudinal edges 11.

Each flap 1a advantageously has a rectangular outline which is delimited by:
fold line 5,
a longitudinal edge 11, and
half the length of the two transverse edges 12.

Furthermore, in the folded state, the comfort mattress 1 advantageously has a rectangular outline which is delimited by:
fold line 5,
the two longitudinal edges 11, superimposed, and
the two transverse edges 12, folded in two

### Peripheral Strip

The comfort mattress 1 advantageously comprises a peripheral strip 8, delimiting the comfort mattress 1 and surrounding the sealed cavities 6.

This peripheral strip 8 advantageously extends along the contour of the comfort mattress 1, for example in a rectangular shape.

This peripheral strip 8 thus advantageously has sections which extend along the two longitudinal edges 11 and the two transverse edges 12.

The peripheral strip 8 advantageously has a width dimension (perpendicular to the adjoining edge 11, 12) ranging from 40 mm to 200 mm.

### Resilient Layer

In general and for example, the resilient layer 7 is in the form of a parallelepiped plate.

Generally speaking and for example, the resilient layer 7 is made up of a foam plate, for example made of recycled material or not.

This foam plate is for example made of elastomer material, for example polyurethane or latex, advantageously with shape memory.

For example, this foam plate is made of rubber granules, agglomerated or not, for example in the form of a parallelepiped plate.

In particular for a resilient layer 7 made of rubber granules, the resilient layer 7 preferably has the following characteristics:
a tensile strength ranging from 5 to 25 MPa, and
an elongation capacity ranging from 300 to 500%.

Again generally, as illustrated in FIG. 2, each resilient layer 7 comprises:
an upper face 71, on the side of the upper sheet 2,
a lower face 72, on the side of the lower sheet 3, and
side faces 73.

In this case, according to the illustrated embodiment:
the lower sheet 3 fits the lower face 72 of the resilient layer 7, and
the upper sheet 2 fits the upper face 71 and the side faces 73 of the resilient layer 7.

In other words, the resilient layers 7 protrude from the side of the upper sheet 2.

For example, the resilient layer 7 is in the form of a parallelepiped plate with:
an upper face 71 and a lower face 72 which are parallel, and
lateral faces 73, forming a rectangular outline.

### Handle(s)

The comfort mattress 1 advantageously comprises at least one handle 9 which is suitable for handling the comfort mattress 1.

Said at least one handle 9 is preferably provided in the peripheral strip 8, for example in the form of a cutout, along the longitudinal edges 11 (FIG. 1 in particular).

Said at least one handle 9 can also be provided at the level of the folding strip 5, on the side of the lower sheet 3, for example in the form of a handle (not shown).

### Implementation

In practice, the comfort mattress 1 can be placed on the ground in its unfolded state (FIG. 1), for example on the floor of a stall.

In this case, the lower sheet 3 rests advantageously on the ground.

If necessary, the comfort mattress 1 can be folded into its folded state (FIG. 3).

This folded state is useful, for example, for transporting the comfort mattress 1 or for forming a floor covering in a vehicle.

For example, for a horse, the comfort mattress 1 can be folded in two, so as to be placed on the floor of an equestrian vehicle. At the place of arrival, the comfort mattress 1 can be removed from the vehicle to be placed on the ground, in an unfolded or folded state depending on the space available.

In general, the handling of the comfort mattress 1 is facilitated by said at least one handle 9.

### Making the Elastic Band

The comfort mattress 1 according to the invention can be manufactured by assembling a set of superimposed underlayers, to form a single-piece type assembly.

The assembly technology can be chosen, for example, from vulcanization, gluing, welding.

For example, as described in connection with FIG. 4, the manufacturing process comprises:
(i) a step of superimposing sub-layers 2, 3 in elastic material comprising two facing surfaces, between which are added:
intermediate means capable of locally preventing the joining of said surfaces opposite said sub-layers 2, 3 to form the sealed cavities 6, or
at least two resilient layers 7,
then
(ii) a step of securing the contact surfaces of said superimposed sub-layers 2, 3, outside the space taken up by the intermediate means and/or resilient layers 7.

The intermediate means advantageously consist of any means avoiding the joining between the facing surfaces of the sub-layers 2, 3 to be assembled.

In the case of vulcanization, the intermediate means consist, for example, of strips or tubes which are advantageously made of a material chosen from:
a fire-resistant film containing a retarder, for example polypropylene, acrylonitrile butadiene styrene,
a layer of silicone,
a layer of a vulcanized elastomeric material, for example a hose made for example from styrene-butadiene rubber (SBR), natural rubber (NR), or ethylene-propylene-diene monomer.

These intermediate means are in particular arranged between two elastomer sub-layers 2, 3 to be assembled with each other.

Of course, various other modifications may be made to the invention within the scope of the appended claims.

1. A comfort mattress, for an animal, particularly for equines, which comfort mattress comprises two sheets, made of elastic material, namely:
an upper sheet, intended to form an upper face of said comfort mattress, and
a lower sheet, intended to form a lower face of the comfort mattress which is adapted to rest on the ground,
which sheets are joined together and define:
a folding strip, suitable for folding said comfort mattress between a folded state, in two, and an unfolded state, and
two sealed cavities, each containing a resilient layer and arranged on either side of said folding strip.

2. The comfort mattress, according to claim 1, wherein said comfort mattress has a rectangular outline comprising two longitudinal edges and two transverse edges, and said folding strip is arranged along a median line, preferably parallel to said longitudinal edges.

3. The comfort mattress, according to claim 2, wherein, in its unfolded state, said comfort mattress has the following dimensions:
a width rating ranging from 1,500 to 2,000 mm, and
a length dimension ranging from 2,000 to 3,000 mm.

4. The comfort mattress, according to claim 2, wherein said folding strip has:
a longitudinal axis, and
a width dimension, perpendicular to said longitudinal axis, ranging from 40 mm to 200 mm.

5. The comfort mattress, according to claim 1, wherein, in its folded state, said folding strip has a radius of curvature ranging from 40 to 80 mm.

6. The comfort mattress, according to claim 1, wherein said comfort mattress comprises a peripheral strip, delimiting said comfort mattress and surrounding said sealed cavities.

7. The comfort mattress, according to claim 6, wherein said peripheral strip (8) has a width dimension ranging from 40 mm to 200 mm.

8. The comfort mattress, according to claim 1, wherein said sheets are secured at said folding strip and/or, where appropriate, said peripheral strip.

9. The comfort mattress, according to claim 1, wherein said resilient layer is constituted by a foam plate.

10. The comfort mattress, according to claim 1, wherein said resilient layer has:
a tensile strength ranging from 10 to 20 MPa, and
an elongation capacity ranging from 300 to 500%.

11. The comfort mattress, according to claim 1, wherein each resilient layer comprises an upper face, a lower face and side faces,
which lower sheet fits the lower face of said resilient layer, and
which upper sheet fits the upper face and the side faces of said resilient layer.

12. The comfort mattress, according to claim 1, wherein each resilient layer has the shape of a parallelepiped plate.

13. The comfort mattress, according to claim 1, wherein said comfort mattress (1) comprises at least one handle, suitable for handling said comfort mattress.

14. The comfort mattress, according to claim 2, wherein said folding strip is arranged along a median line, parallel to said longitudinal edges.

15. The comfort mattress, according to claim 9, wherein said resilient layer is constituted by a foam plate, constituted by agglomerated or non-agglomerated rubber granules.

16. The comfort mattress, according to claim 13, wherein said comfort mattress comprises at least one handle, suitable for handling said comfort mattress, which at least one handle is provided:
in said peripheral strip, for example in the form of a cutout, in combination with claim 6, and/or
at the folding strip, on the side of the lower sheet.
